(19) United States
(12) Patent Application Publication
(10) Pub. No.: US 2025/0318543 A1
(43) Pub. Date: Oct. 16, 2025

(54) OIL AND/OR FAT FOR GLAZING CHOCOLATE

(71) Applicant: FUJI OIL HOLDINGS INC., Osaka (JP)

(72) Inventor: Kazuhiro YAMAMOTO, Ibaraki (JP)

(73) Assignee: FUJI OIL HOLDINGS INC., Osaka (JP)

(21) Appl. No.: 18/632,230

(22) Filed: Apr. 10, 2024

(51) Int. Cl. A23G 1/36; A23D 7/04

(52) U.S. Cl. CPC A23G 1/36; A23D 7/04; A23G 2200/08; A23G 2220/20

(57) ABSTRACT

Problem:

Provided is an oil and/or fat capable of improving the gloss of chocolates.

Resolution means:

The randomly interesterified oil and/or fat satisfying the following Requirements 1 to 3 has an effect of improving the gloss of chocolates:
1. containing from 6.5 to 20 mass % of a saturated fatty acid having 20 or more carbon atoms;
2. containing from 40 to 70 mass % of an unsaturated fatty acid having 18 carbon atoms; and
3. containing from 13 to 35 mass % of a saturated fatty acid having 18 carbon atoms.

### TECHNICAL FIELD

The present invention relates to an oil and/or fat that can be used for glazing chocolates and to a method of producing the same.

### BACKGROUND ART

Patent Document 1, an application entitled “INTERESTERIFIED OIL AND/OR FAT, AND CHOCOLATE USING SAID INTERESTERIFIED OIL AND/OR FAT”, describes an issue of: “providing an interesterified oil and/or fat (hard butter) capable of maintaining gloss of a produced chocolate for a long period of time when used in chocolate production without needing to contain a significant amount of fatty acid having 20 or more carbon atoms as a constituent fatty acid”.

Patent Document 2, an application entitled “OIL AND/OR FAT COMPOSITION FOR CHOCOLATES”, describes an issue of: “providing a chocolate with inhibited quality deterioration over time and an oil and/or fat composition for use in the chocolate, the chocolate having rich flavor containing cocoa butter and excellent melting properties without a tempering operation when producing chocolates”. The effect of the invention describes “ . . . is an oil and/or fat composition for chocolates capable of producing chocolates with inhibited quality deterioration such as gloss”. As a specific configuration, disclosed is “an oil and/or fat composition for chocolates obtained by interesterifying an oil and/or fat containing 30% or more of a fatty acid having 12 or less carbon atoms and an oil and/or fat containing 30% or more of a saturated fatty acid having 20 or more carbon atoms”.

### CITATION LIST

### Patent Document

[Patent Document 1] WO 2016/133004 A
[Patent Document 2] WO 2007/129590 A

### SUMMARY OF INVENTION

### Technical Problem

An object of the present invention is to provide an oil and/or fat capable of improving gloss of chocolates.

### Solution to Problem

The present inventors have conducted intensive studies to solve the issues. In the interesterified oil and/or fat according to Patent Document 1, “the content of the fatty acid having 12 or less carbon atoms in all constituent fatty acids is from 15 to 30 mass %” is an essential requirement. However, for example, when lauric fat, which has 12 carbon atoms, is hydrolyzed, so-called soapy flavor may be generated, and thus the use of lauric fat in products having a long shelf life such as chocolates may be difficult.

Also in Patent Document 2, the same issue as in Patent Document 1 may arise.

The present inventors have further conducted studies and found that a randomly interesterified oil and/or fat satisfying the following Requirements 1 to 3 has an effect of improving the gloss of chocolates, and thus completed the present invention:
1. containing from 6.5 to 20 mass % of a saturated fatty acid having 20 or more carbon atoms,
2. containing from 40 to 70 mass % of an unsaturated fatty acid having 18 carbon atoms, and
3. containing from 13 to 35 mass % of a saturated fatty acid having 18 carbon atoms.

That is, the present invention relates to the following.

(1) A randomly interesterified oil and/or fat satisfying all of the following Requirements 1 to 3:
1. containing from 6.5 to 20 mass % of a saturated fatty acid having 20 or more carbon atoms;
2. containing from 40 to 70 mass % of an unsaturated fatty acid having 18 carbon atoms; and
3. containing from 13 to 35 mass % of a saturated fatty acid having 18 carbon atoms.

(2) The randomly interesterified oil and/or fat according to the above-mentioned (1), wherein a total of the fatty acids according to the above Requirements 1 to 3 is 90 mass % or more.

(3) A chocolate including from 2 to 10 mass % of the oil and/or fat according to the above-mentioned (1) or (2), the chocolate having improved gloss.

(4) A method of producing a randomly interesterified oil and/or fat, the method including randomly interesterifying an oil and/or fat satisfying all of the following Requirements 1 to 3:
1. containing from 6.5 to 20 mass % of a saturated fatty acid having 20 or more carbon atoms;
2. containing from 40 to 70 mass % of an unsaturated fatty acid having 18 carbon atoms; and
3. containing from 13 to 35 mass % of a saturated fatty acid having 18 carbon atoms.

(5) The method of producing a randomly interesterified oil and/or fat according to the above-mentioned (4), wherein a total of the fatty acids according to the above Requirements 1 to 3 is 90 mass % or more.

(6) A method of improving gloss of chocolates, the method including blending from 2 to 10 mass % of the oil and/or fat according to the above-mentioned (1) into a chocolate.

(7) A method of improving gloss of chocolates, the method including blending from 2 to 10 mass % of the oil and/or fat according to the above-mentioned (2) into a chocolate.

(8) A chocolate gloss improver including the oil and/or fat according to the above-mentioned (1) as an active ingredient.

(9) A chocolate gloss improver including the oil and/or fat according to the above-mentioned (2) as an active ingredient.

### Advantageous Effects of Invention

According to the present invention, the gloss of chocolates can be improved.

### DESCRIPTION OF EMBODIMENTS

The present invention relates to a randomly interesterified oil and/or fat. Here, random interesterification is a technique in which a catalyst is added to an oil and/or fat mixture, which is a base material, and randomly exchanges fatty acids to be bonded.

As a catalyst for use in random interesterification, either a chemical catalyst or an enzyme can be used. Any ordinary technique can be used.

The randomly interesterified oil and/or fat according to the present invention satisfies the following Requirements 1 to 3:
1. containing from 6.5 to 20 mass % of a saturated fatty acid having 20 or more carbon atoms;
2. containing from 40 to 70 mass % of an unsaturated fatty acid having 18 carbon atoms; and
3. containing from 13 to 35 mass % of a saturated fatty acid having 18 carbon atoms.

Each of the fatty acids referred to herein is present as a fatty acid constituting an oil and/or fat, that is, a triglyceride. Hereinafter, each item will be described in more detail.

As a supply source of the saturated fatty acid having 20 or more carbon atoms, an extremely hardened high-erucic-acid rapeseed oil can be used. Here, high-erucic-acid rapeseed oil is a known type of rapeseed oil and contains about 40% of erucic acid. Extremely hardened high-erucic-acid rapeseed oil is obtained through extreme hardening of this type of oil by a known method.

In the randomly interesterified oil and/or fat according to the present invention, the saturated fatty acid having 20 or more carbon atoms has to be contained in an amount of from 6.5 to 20 mass %, but this amount is more desirably from 7 to 13 mass %, and further desirably from 7 to 10 mass %. When the saturated fatty acid having 20 or more carbon atoms is contained in an appropriate amount, the gloss can be preferably improved in chocolate in which the randomly interesterified oil and/or fat is used.

As a supply source of the unsaturated fatty acid having 18 carbon atoms, in addition to a liquid oil such as soybean oil or rapeseed oil, oils and/or fats obtained by fractionation of oils and/or fats that have been hardened or interesterified can also be used.

The randomly interesterified oil and/or fat according to the present invention has to contain from 40 to 70 mass % of an unsaturated fatty acid having 18 carbon atoms, but this amount is more desirably from 45 to 65 mass %, and even more desirably from 50 to 60 mass %. When an appropriate amount of the unsaturated fatty acid having 18 carbon atoms is contained, the gloss can be preferably improved in chocolate in which the randomly interesterified oil and/or fat is used.

As a supply source of the saturated fatty acid having 18 carbon atoms, a hardened oil and/or fat containing a large amount of unsaturated fatty acid having 18 carbon atoms or a fractionated oil and/or fat of various kinds can be used.

The randomly interesterified oils and/or fats according to the present invention have to contain from 13 to 35 mass % of a saturated fatty acid having 18 carbon atoms, but this amount is more desirably from 16 to 33 mass %, and even more desirably from 20 to 30 mass %. When an appropriate amount of the saturated fatty acid having 18 carbon atoms is contained, the gloss can be preferably improved in chocolate in which the randomly interesterified oil and/or fat is used.

Although the above-mentioned description has been made with assuming oils and/or fats each satisfying the above-mentioned three requirements, it is naturally possible to use one oil and/or fat satisfying two or more requirements.

The random interesterification referred to herein in the present invention refers to a processing method in which fatty acids bonded to oils and/or fats are randomly interesterified using a catalyst.

The catalyst used in the present invention may be a chemical catalyst or a lipase having a random interesterification activity. A chemical catalyst is more desirable. An example of the catalyst used can be sodium methylate. The chemical catalyst is desirable because it is inexpensive and completes reaction in a short period.

When random interesterification is conducted using a lipase, a commercially available lipase can be used. Any type of lipase may be used as long as it has a random interesterification activity. The interesterification reaction with a lipase can be appropriately set according to the optimum conditions of the lipase to be used.

In the randomly interesterified oil and/or fat according to the present invention, it is necessary that a total of the saturated fatty acid having 20 or more carbon atoms, the unsaturated fatty acid having 18 carbon atoms, and the saturated fatty acid having 18 carbon atoms is 90 mass % or more. This amount is more desirably 92 mass % or more, and even more desirably 94 mass % or more. When this value is appropriate, the gloss can be preferably improved in chocolate in which the randomly interesterified oil and/or fat is used.

The chocolate as referred to in the present invention refers to not only chocolates, quasi-chocolates, and chocolate-based food products defined by the National Chocolate Industry Fair Trade Council and the Chocolate-Based Food Fair Trade Council, but also products containing an oil and/or fat as an essential component, in which auxiliary raw materials such as saccharides, powder milk, a cacao raw material (cacao mass, cocoa, and cocoa butter), fruit juice powder, fruit powder, a flavoring agent, an emulsifier, a flavor, or a coloring agent are blended as needed at arbitrary proportions.

Representative examples of the chocolate can include sweet chocolates, milk chocolates, and also white chocolates. In addition, products produced by adding a fruit component to these are also included.

The randomly interesterified oil and/or fat according to the present invention is desirably contained in the chocolate in an amount of from 2 to 10 mass %. This amount is more desirably from 3 to 7 mass %, and even more desirably from 3 to 5 mass %. When an appropriate amount of the randomly interesterified oil and/or fat according to the present invention is present in chocolate, the gloss of the chocolate can be improved.

The improvement of the gloss of a chocolate can be determined by visual observation. A specific evaluation method will be described in Examples. In short, the presence or absence of an effect is determined based on whether or not the gloss is improved when a predetermined oil and/or fat is added to a chocolate as compared with a case where the oil and/or fat is not added.

The present invention can also be regarded as a method of producing a predetermined randomly interesterified oil and/or fat. In the random interesterification, the composition of the oil and/or fat is important. The composition of the oil and/or fat in the production method according to the present invention satisfies the following Requirements:
1. containing from 6.5 to 20 mass % of a saturated fatty acid having 20 or more carbon atoms;
2. containing from 40 to 70 mass % of an unsaturated fatty acid having 18 carbon atoms; and
3. containing from 13 to 35 mass % of a saturated fatty acid having 18 carbon atoms.

For the random interesterification itself, a known method can be adopted.

Furthermore, in the composition of the oil and/or fat satisfying the above-mentioned Requirements, it is desirable that a total amount of the saturated fatty acid having 20 or more carbon atoms, the unsaturated fatty acid having 18 carbon atoms, and the saturated fatty acid having 18 carbon atoms is 90 mass % or more.

The present invention can also be regarded as a method of improving the gloss of chocolates. Specifically, the method is that the randomly interesterified oil and/or fat according to the present invention is blended into a chocolate in an amount of from 2 to 10 mass %.

The present invention can also be regarded as an invention relating to a gloss improver for chocolates. Specifically, the present invention is characterized in that the randomly interesterified oil and/or fat according to the present invention is used as an active ingredient. The amount of the randomly interesterified oil and/or fat according to the present invention in said agent is desirably from 2 to 100 mass %, more desirably from 10 to 90 mass %, and even more desirably from 30 to 70 mass %, because the amount of said randomly interesterified oil and/or fat may be from 2 to 10 mass % in the final chocolate. When the amount of said randomly interesterified oil and/or fat in said agent is appropriate, the effect of the present invention can be realized in a wide range of addition amounts.

The embodiments of the present invention will be described in more detail with reference to Examples below.

### Examples

Study 1 Preparation of Randomly Interesterified Oils and/or Fats

Randomly interesterified oils and/or fats were prepared according to “◯ Method for Preparing Randomly Interesterified Oil and/or Fat” with the formulations presented in Table 1-1.

Table 1-1 also indicates the amount of the saturated fatty acid having 20 or more carbon atoms, the amount of the unsaturated fatty acid having 18 carbon atoms, the amount of the saturated fatty acid having 18 carbon atoms, and the total amount of these in each randomly interesterified oil and/or fat.

TABLE 1-1
Formulations for Randomly Interesterified Oils and/or Fats

| | | | | Comparative | Comparative | |
|---|---|---|---|---|---|---|
| | Example 1-1 | Example 1-2 | Example 1-3 | Example 1-1 | Example 1-2 | Example 1-4 |
| Shea olein | 90.0% | 67.5% | 45.0% | 22.5% | — | 80.0% |
| Soybean oil | — | 22.5% | 45.0% | 67.5% | 90.0% | — |
| Extremely hardened | 10.0% | 10.0% | 10.0% | 10.0% | 10.0% | 20.0% |
| high-erucic-acid | | | | | | |
| rapeseed oil | | | | | | |
| | 100.0% | 100.0% | 100.0% | 100.0% | 100.0% | 100.0% |

(Unit of formulation is mass %)

| | | | | | | |
|---|---|---|---|---|---|---|
| (1) Amount of saturated | 7.4% | 7.2% | 7.0% | 6.7% | 6.5% | 12.9% |
| fatty acid having 20 or | | | | | | |
| more carbon atoms | | | | | | |
| (mass %) | | | | | | |
| (2) Amount of | 58.5% | 62.8% | 67.1% | 71.4% | 75.7% | 52.0% |
| unsaturated fatty acid | | | | | | |
| having 18 carbon atoms | | | | | | |
| (mass %) | | | | | | |
| (3) Amount of saturated | 28.9% | 23.5% | 18.2% | 12.9% | 7.5% | 30.0% |
| fatty acid having 18 | | | | | | |
| carbon atoms (mass %) | | | | | | |
| Total of (1) to (3) | 94.8% | 93.5% | 92.2% | 91.0% | 89.7% | 94.9% |
| (mass %) | | | | | | |

| | | | | Comparative | Comparative | Comparative |
|---|---|---|---|---|---|---|
| | Example 1-5 | Example 1-6 | Example 1-7 | Example 1-3 | Example 1-4 | Example 1-5 |
| Shea olein | 70.0% | — | — | — | — | — |
| Soybean oil | — | 5.0% | 25.0% | 70.0% | — | — |
| Extremely hardened high- | 30.0% | 10.0% | 10.0% | 10.0% | 10.0% | 10.0% |
| erucic-acid rapeseed oil | | | | | | |
| Fractionated soft fraction of | — | 85.0% | 65.0% | 20.0% | — | — |
| sunflower oil interesterified | | | | | | |
| oil | | | | | | |
| Rapeseed oil | — | — | — | — | 35.0% | 55.0% |
| Corn oil | — | — | — | — | 55.0% | 35.0% |
| | 100.0% | 100.0% | 100.0% | 100.0% | 100.0% | 100.0% |

(Unit of formulation is mass %)

| | | | | | | |
|---|---|---|---|---|---|---|
| (1) Amount of saturated fatty | 18.4% | 6.7% | 6.6% | 6.6% | 6.0% | 6.1% |
| acid having 20 or more | | | | | | |
| carbon atoms (mass %) | | | | | | |
| (2) Amount of unsaturated | 45.5% | 60.9% | 64.4% | 72.2% | 79.2% | 80.2% |
| fatty acid having 18 carbon | | | | | | |
| atoms (mass %) | | | | | | |
| (3) Amount of saturated fatty | 31.2% | 28.3% | 23.4% | 12.4% | 5.8% | 5.8% |
| acid having 18 carbon atoms | | | | | | |
| (mass %) | | | | | | |
| Total of (1) to (3) (mass %) | 95.1% | 95.9% | 94.5% | 91.2% | 91.0% | 92.1% |

As the shea olein, “Purified Shea Olein” (iodine value: 67) that had been purified in Fuji Oil Co., Ltd. was used.
As the soybean oil, “Soybean White Squeezed Oil” available from Fuji Oil Co., Ltd. was used.
As the extremely hardened high-erucic-acid rapeseed oil, one obtained by extremely hardening rapeseed oil containing 43% or more of erucic acid was used.
As the fractionated soft part of sunflower oil interesterified oil, 30 parts by weight of high oleic acid sunflower oil having an oleic acid content of 86% and 70 parts by weight of ethyl stearate were mixed, the mixture was then subjected to interesterification using a lipase having 1,3-position selectivity to obtain a reaction oil, ethyl ester was distilled off from this reaction oil by distillation, solvent fractionation was conducted using acetone, decoloring and deodorization were conducted according to known methods, and the obtained fractionated low melting point part (iodine value: 59.0) was used.
As the rapeseed oil, “Salad Oil for Confectionary”, which is an edible rapeseed oil available from Fuji Oil Co., Ltd., was used.
As the corn oil, “Corn Refined Oil” available from Tsuji Oil Co., Ltd. was used.

Method for Preparing Randomly Interesterified Oil and/or Fat

1. The oils and/or fats to be used were melted and mixed at from 50 to 65° C. according to the formulation.

2. Random interesterification was conducted using sodium methylate as a catalyst with respect to 100 parts by weight of the oil and/or fat.

3. Decolorization and deodorization were conducted in a known manner.

### Study 2 Evaluation

Each of the oils and/or fats obtained in Study 1 was added to a commercially available chocolate to evaluate the gloss improving effect. The specific method was described in “◯ Method for Evaluating Gloss Improving Effect of Each Oil and/or Fat”.

The evaluation results are described in Table 2-1.

Method for Evaluating Gloss Improving Effect of Each Oil and/or Fat
1. A commercially available chocolate (“Sweet Chocolate” available from Fuji Oil Co., Ltd.) was melted in a vessel in a hot water bath at 55° C.

2. According to Table 2, each oil and/or fat was added and homogenized.

3. Tempering operation was conducted.

4. The resulting mixture was poured into a mold and left at 15° C. for 30 minutes.

5. The gloss was evaluated in comparison with a chocolate (control) obtained by adding cocoa butter instead of each oil and/or fat in the above 2 and conducting similar operations.

The gloss was evaluated according to the following criteria by the collective judgment of three panelists regularly involved in chocolate development tasks.

◯: The gloss was judged to be clearly improved as compared with the control.

Δ: The gloss was judged to be slightly improved as compared with the control.

x: It was judged that there was no improvement in gloss as compared with the control.

◯ and Δ were determined to be acceptable.

TABLE 2-1

| | | | | Comparative | Comparative | |
|---|---|---|---|---|---|---|
| | Example 2-1 | Example 2-2 | Example 2-3 | Example 2-1 | Example 2-2 | Example 2-4 |
| Commercially available chocolate | 97 | 97 | 97 | 97 | 97 | 97 |
| Oil and/or fat in Example 1-1 | 3 | — | — | — | — | — |
| Oil and/or fat in Example 1-2 | — | 3 | — | — | — | — |
| Oil and/or fat in Example 1-3 | — | — | 3 | — | — | — |
| Oil and/or fat in Comparative | — | — | — | 3 | — | — |
| Example 1-1 | | | | | | |
| Oil and/or fat in Comparative | — | — | — | — | 3 | — |
| Example 1-2 | | | | | | |
| Oil and/or fat in Example 1-4 | — | — | — | — | — | 3 |
| Total | 100 | 100 | 100 | 100 | 100 | 100 |

(Unit of formulation is mass %)

| | | | | | | |
|---|---|---|---|---|---|---|
| Gloss evaluation | ∘ | ∘ | Δ | x | x | ∘ |

| | | | | Comparative | Comparative | Comparative | Comparative |
|---|---|---|---|---|---|---|---|
| | Example 2-5 | Example 2-6 | Example 2-7 | Example 2-3 | Example 2-4 | Example 2-5 | Example 2-6 |
| Commercially available | 97 | 97 | 97 | 97 | 97 | 97 | 97 |
| chocolate | | | | | | | |
| Oil and/or fat in Example 1-5 | 3 | — | — | — | — | — | — |
| Oil and/or fat in Example 1-6 | — | 3 | — | — | — | — | — |
| Oil and/or fat in Example 1-7 | — | — | 3 | — | — | — | — |
| Oil and/or fat in Comparative | — | — | — | 3 | — | — | — |
| Example 1-3 | | | | | | | |
| Oil and/or fat in Comparative | — | — | — | — | 3 | — | — |
| Example 1-4 | | | | | | | |
| Oil and/or fat in Comparative | — | — | — | — | — | 3 | — |
| Example 1-5 | | | | | | | |
| Formulation in Example 1-1, | — | — | — | — | — | — | 3 |
| except no interesterification was | | | | | | | |
| conducted | | | | | | | |
| Total | 100 | 100 | 100 | 100 | 100 | 100 | 100 |

(Unit of formulation is mass %)

| | | | | | | | |
|---|---|---|---|---|---|---|---|
| Gloss evaluation | Δ | ∘ | ∘ | x | x | x | x |

| | Example 2-8 | Example 2-9 | Example 2-10 | Example 2-11 |
|---|---|---|---|---|
| Commercially available chocolate | 98 | 95 | 93 | 90 |
| Oil and/or fat of Example 1-1 | 2 | 5 | 7 | 10 |
| Total | 100 | 100 | 100 | 100 |

(Unit of formulation is mass %)

| | | | | |
|---|---|---|---|---|
| Gloss evaluation | ∘ | ∘ | ∘ | Δ |

### DISCUSSION

It was confirmed that, when the interesterified oil according to the present invention was added, the gloss of chocolates was improved.

1. A randomly interesterified oil and/or fat satisfying all of the following Requirements 1 to 3:
1. containing from 6.5 to 20 mass % of a saturated fatty acid having 20 or more carbon atoms;
2. containing from 40 to 70 mass % of an unsaturated fatty acid having 18 carbon atoms; and
3. containing from 13 to 35 mass % of a saturated fatty acid having 18 carbon atoms.

2. The randomly interesterified oil and/or fat according to claim 1, wherein a total of the fatty acids according to the above Requirements 1 to 3 is 90 mass % or more.

3. A chocolate comprising from 2 to 10 mass % of the oil and/or fat according to claim 1, the chocolate having improved gloss.

4. A method of producing a randomly interesterified oil and/or fat, the method comprising randomly interesterifying an oil and/or fat satisfying all of the following Requirements 1 to 3:
1. containing from 6.5 to 20 mass % of a saturated fatty acid having 20 or more carbon atoms;
2. containing from 40 to 70 mass % of an unsaturated fatty acid having 18 carbon atoms; and
3. containing from 13 to 35 mass % of a saturated fatty acid having 18 carbon atoms.

5. The method of producing a randomly interesterified oil and/or fat according to claim 4, wherein a total of the fatty acids according to the above Requirements 1 to 3 is 90 mass % or more.

6. A method of improving gloss of chocolates, the method comprising blending from 2 to 10 mass % of the oil and/or fat according to claim 1 into a chocolate.

7. A method of improving gloss of chocolates, the method comprising blending from 2 to 10 mass % of the oil and/or fat according to claim 2 into a chocolate.

8. A chocolate gloss improver comprising the oil and/or fat according to claim 1 as an active ingredient.

9. A chocolate gloss improver comprising the oil and/or fat according to claim 2 as an active ingredient.

10. A chocolate comprising from 2 to 10 mass % of the oil and/or fat according to claim 2, the chocolate having improved gloss.
